(19) United States
(12) Patent Application Publication
(10) Pub. No.: US 2012/0197925 A1
(43) Pub. Date: Aug. 2, 2012

(54) Optimization of Database Driver Performance

(75) Inventors: Sachin Balagopalan, Easton, MA (US); Krishnamohan Dantam, Chelmsford, MA (US); Ravi K. Kosaraju, Johnston, RI (US)

(73) Assignee: International Business Machines Corporation, Armonk, NY (US)

(21) Appl. No.: 13/016,025

(22) Filed: Jan. 28, 2011

(51) Int. Cl. G06F 17/30

(52) U.S. Cl. 707/769; 707/E17.014

(57) ABSTRACT

Memory usage of a database driver is reduced by accessing database elements from a database object within a database during a database operation, generating an element object for each different value of accessed database elements, where the database object includes at least two database elements having the same unique value such that a total number of accessed database elements is greater than a total number of generated element objects, storing the generated element objects in a storage structure, and providing the generated element objects from the storage structure within results for the database operation.

### BACKGROUND

1. Technical Field

The present invention relates to database drivers for interacting with database management systems, such as a relational database management systems (RDMS).

2. Discussion of the Related Art

In typical web based applications in which an application is used to access data from a database management system, a significant amount of memory can be consumed by data that is read from the database management system to a client driver. In particular, most of the memory usage by a database driver results from data records that are retrieved in a result set based upon a particular query of the database management system by the client. A substantial portion of the data is read into a cache or memory of the client by the driver as immutable objects such as strings.

For certain types of columns in a database table of values, the variance in values can be very small. For example, a database table may list information about persons (e.g., employees, customers, organization members, etc.) in which a table column may provide information about the gender of each person. Accordingly, this column may only include two distinct values for “male” or “female”. Current database drivers, such as Java DataBase Connectivity (JDBC) drivers, fetch or retrieve the raw data from a database management system based upon a client query, and these drivers generate a new copy on the client side of each object for every row even if the object is an immutable object and/or the object value is the same as values for previously retrieved objects. (Java and all Java-based trademarks and logos are trademarks or registered trademarks of Oracle and/or its affiliates.) Thus, in a scenario as described above in which a column only contains gender data (i.e., “male” or “female” values), the driver will read this value as a string for all rows and store an object in this column for each row of data that is retrieved. In particular, in an example in which there are 100 rows retrieved by the driver due to the client query, the driver will generate and store 100 string objects corresponding to the “male” and/or “female” values of the rows. This results in generating a large memory footprint for the same values on the client side, which becomes more significant when the query generates a large number of results (e.g., several thousand rows of data) to be processed and stored by the client driver.

### BRIEF SUMMARY

Accordingly, embodiments of the present invention include a method, a computer program product and a system for processing operations to reduce memory usage of a database driver, where the processing operations comprise accessing database elements from a database object within a database during a database operation, generating an element object for each different value of accessed database elements, where the database object includes at least two database elements having the same unique value such that a total number of accessed database elements is greater than a total number of generated element objects, storing the generated element objects in a storage structure, and providing the generated element objects from the storage structure within results for the database operation.

The above and still further features and advantages of embodiments of the present invention will become apparent upon consideration of the following detailed description thereof, particularly when taken in conjunction with the accompanying drawings wherein like reference numerals in the various figures are utilized to designate like components.

### BRIEF DESCRIPTION OF THE SEVERAL VIEWS OF THE DRAWINGS

FIG. 1 is a block diagram illustrating an example client with database driver and database for performing a database query while optimizing driver performance in accordance with the present invention.

FIG. 2 provides a flowchart depicting an example method of optimizing driver performance by reducing memory storage of a database driver during processing of a database query using, e.g., the system of FIG. 1.

### DETAILED DESCRIPTION

In accordance with embodiments of the present invention, a method, system and computer program product provide optimization of driver performance by reducing the amount of memory used when obtaining data from a database based upon a client query (e.g., a Structured Query Language or SQL statement for accessing data from a database).

In an example embodiment, a relational database management system is provided including one or more databases, where each database includes one or more tables of data, including rows of data records with columns categorizing different types of information for each record. In response to a client query for records, the database management system retrieves records from the one or more tables that satisfy criteria in the client query and provides such records in a database object referred to as a result set, where the result set is accessible by the client. Many of the data values within the result set are typically immutable objects such as strings.

In accordance with the present invention, when a query by a client is made for data managed by a database management system, the database management system communicates to the client driver not only the database record results of the query but also information regarding a frequency with which unique values occur (i.e., a degree of re-use) in each column of data that is retrieved from the query. The database management system computes the frequency or degree of re-use in unique values for each column of the result set and provides this information as metadata to the client driver. Before an immutable value is returned to the driver from the result set, the driver is configured to determine whether the degree of re-use is high for the column with which the immutable value is associated. If the degree of re-use is determined to be high (e.g., exceeding a predetermined threshold value), the driver will generate a cache for this table column.

The driver fetches a raw column data value from the result set and compares it with values in the cache associated with the column to determine whether the value is already in the cache. If it is not, the immutable object is generated from the database raw data and also added to the cache associated with the column. If the driver finds the value within the cache, then it returns the immutable object from the cache instead of generating an identical immutable object from the database raw data. Thus, a high occurrence of the same unique values in a result set of a query does not result in a repetition of the same immutable objects for a particular column, but instead limits the storage by the client driver of immutable objects for this column to the number of unique values within this column.

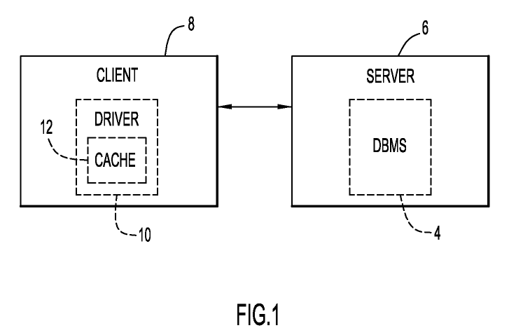

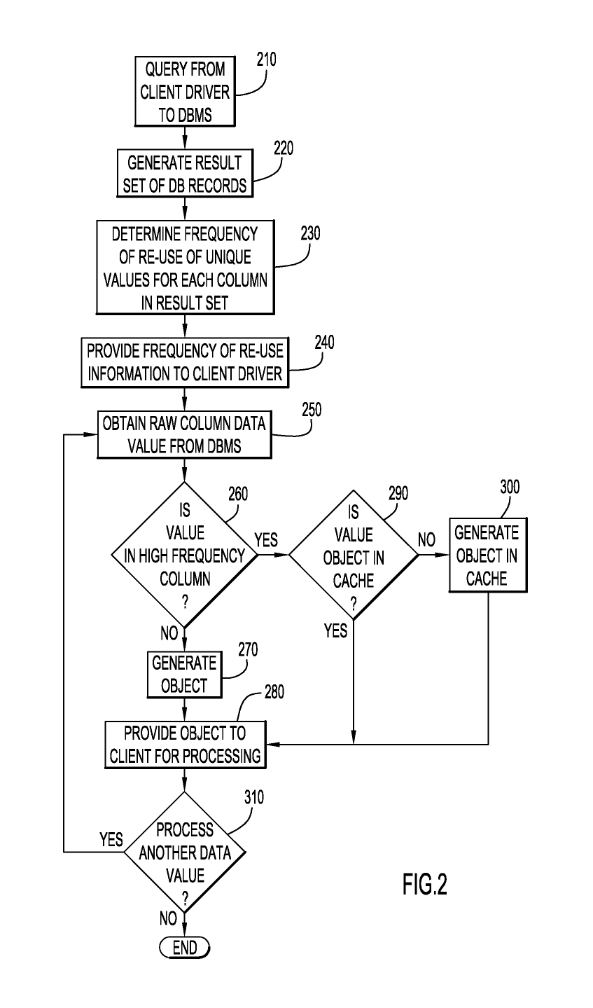

An example embodiment of the present invention is now described with reference to the block diagram of FIG. 1 and the flowchart of FIG. 2, in which a relational database management system (RDBMS) and a Java DataBase Connectivity (JDBC) driver that queries the RDBMS are utilized. However, it is noted that the invention is not limited to any specific database management system or Java based client driver using Java. For example, any other types of suitable drivers (including, without limitation, a database driver providing an interface for a Perl programming language) and different types of databases can be utilized for optimizing driver performance in accordance with the present invention.

Referring to FIG. 1, system 2 includes a database management system (DBMS) 4 within a server 6 that communicates with a client 8. The client 8 includes a suitable driver module 10, in this example a JDBC driver that enables a Java application to interact with DBMS 4. The client 8 further includes a memory cache module 12 to store objects corresponding with unique values having a high frequency of re-use in the search results of a database query. The DBMS server 6 facilitates operations including, without limitation, retrieval, insertion and deletion of records within the DBMS 4 in response to queries, insert and other SQL statements. The DBMS server 6 can communicate with a client driver 10 via any suitable connection including, without limitation, via cloud computing, via network computing in which the DBMS server 6 is operatively coupled to one or more other servers, client drivers or other devices, where the DBMS server 6 can be operatively coupled to one or more other servers, client drivers and/or other devices via any suitable type of carrier wave or signal for transfer of data from one source to another utilizing a suitable communication medium (e.g., bulletin board, network, LAN, WAN, Intranet, Internet, etc.).

Each of the database management system, database server, client, client driver module and cache module can be configured as any suitable computer systems implemented by any type of hardware and/or other processing circuitry. In particular, the database management system, database server, client and client driver may be implemented by any quantity of conventional or other computer systems or devices (e.g., computer terminals, personal computers of all configurations, including IBM-compatible, tablet, laptop, etc.), cellular telephones, personal data assistants etc., and may include any available operating system and any available or custom software (e.g., browser software, communications software, word processing software, etc.). These systems may include types of displays and input devices (e.g., keyboard, mouse, voice recognition, etc.) to enter and/or view information.

Referring to FIG. 2, the client driver 10 communicates a query for information from the DBMS 4 (step 210). The DBMS server 6 retrieves database records from one or more database tables of one or more databases within the DBMS 4 that satisfy the query and generates a result set of the database records for the client driver 10 (step 220).

The DBMS server 6 also determines a degree of re-use or a frequency with which unique values are re-used for each column in the result set of database records that is generated based upon the query (step 230). The determination of frequency of re-use of values within table columns can be performed during operation of the database (e.g., the variance of data with table columns can be periodically determined and also updated based upon changes to the data resulting from processing operations such as insert, delete and update statements). The determination can also be statistically predetermined. In an example embodiment, the determination of frequency of re-use of column values can be performed only for data that has been retrieved in the result set based upon the database query.

In an example scenario in which retrieved data records correspond with persons (e.g., company employees, customers, members of an organization, etc.), a column in the database table that may have a high degree of re-use of certain unique values may be a gender column that only has two immutable values of “male” and “female”. In an example embodiment, the DBMS server 6 determines, for each column in the result set, the total number of rows and total number of unique values for that column. Thus, in a scenario in which a gender column in the result set includes only two unique values (“male” and “female”), and there are 10,000 data records returned in a result set, the frequency of re-use of unique values could be determined as ratio of rows/number of unique values, or a ratio of 5,000. Other examples of columns that might include a high frequency of re-use for unique values include, without limitation, a customer table including a column with type of credit card (where only a few types of credit cards occur within the credit card column), an employee table for a company in which one column includes employee division (where there are a small number of different divisions), etc.

In another example embodiment, the DBMS server 6 can separately determine the degree of re-use of each unique value within each column of the result set. This allows the DBMS server 6 to determine with a greater degree of specificity which one or more unique values occur within a particular column with the greatest frequency, which can be useful for operations in which a large number of database records (e.g., several hundred thousand or more) are processed and it may be desirable to process only the unique values having the greatest frequency of re-use within the column differently from the other values.

The DBMS server 6 provides information (e.g., as metadata) regarding the degree or frequency of re-use of unique values for each column of the result set of data records to the client driver 10 (step 240).

During fetching or retrieval of values from the result set from the DBMS 4 by the client driver 10, the client driver evaluates the degree or frequency of re-use of unique values for each table column of the result set. In the event the frequency of re-use for a particular table column in the result set exceeds a predetermined or preset threshold value, the values for this column are processed differently by the client driver 10. In particular, referring to FIG. 2, the client driver 10 retrieves a raw column data value from the result set in the DBMS 4 (Step 250). The driver 10 next determines whether the raw column data value is in a column that has been determined to have a high frequency of re-use of unique values (step 260). In the event the raw column data value is not in such a high frequency re-use column, the client driver 10 generates an object for the raw column data value (step 270) and provides the object to the client for processing (step 280).

In the event the raw column data value is in a column that has been determined by the driver 10 as being a high frequency re-use column, the driver 10 next determines whether an object corresponding with the raw column data value is already stored in the memory cache module 12 of client 8 (step 290). In the event this object is already stored in the memory cache module 12 (i.e., this same column value has already been processed for a previous record by the client driver), the driver 10 proceeds to providing the object to the client 8 for further processing (step 280). In the event there is no object corresponding with this raw column data value, the driver 10 generates an object corresponding with this value and stores the object within the memory cache module 12 (step 300), and the driver 10 then proceeds to providing the object to the client 8 for further processing (step 280). The further processing of the objects by the client 8 is in relation to providing results based upon the query requested by the client.

After the object corresponding with the raw column data value has been provided to the client 8 for processing, the driver 10 continues processing the result set by determining whether another data value needs to be processed or whether the end of the data values in the result set has been reached (step 310). If there is another data value that needs to be processed, the driver 10 repeats the process starting with obtaining the next raw column data value from the DBMS 4 (step 250).

In a modified version of the previously described embodiment, the database management system provides key or coded values to the result set instead of the raw data for those unique values having a high frequency of re-use. The coded values would require less memory than the raw data for the unique values. In an example for a gender column of data in a result set, the unique value of “male” could be provided as a first coded value (for example, “0”), while the unique value of “female” could be provided as a second coded value (for example, “1”). The database management system can provide the “key” for coded values and corresponding raw data values in any suitable manner. For example, the “key” can be provided from the database management system to the client driver as metadata after the result set has been generated. In another example, the first retrieval of a unique database value by the client driver from the database management system can include both the raw data value and the coded value, whereas subsequent repetitions of retrieval of the same unique database value would only include the coded value. The client driver can save the coded value with the raw data value in the cache module for easy lookup upon receiving subsequent coded values from the database management system during retrieval of data from the result set.

Thus, the embodiments of the present invention enhance performance of a query for data from a database management system by processing data values in the result while minimizing or preventing the generation of multiple objects at the client side for the high frequency unique values that may occur in one or more table columns. This reduces memory usage on the client side and also reduces the size of garbage to be collected and processed (e.g., erasing of objects generated after processing of the data from the result set by the client). In addition, implementation of the cache to store objects for re-use (instead of generating multiple numbers of the same objects for high frequency of re-use data values) can ensure that memory usage during processing of the result set does not exceed a predetermined limit.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Perl, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method of reducing memory usage of a database driver comprising:
accessing database elements from a database object within a database during a database operation;
generating an element object for each different value of accessed database elements, wherein the database object includes at least two database elements having the same unique value such that a total number of accessed database elements is greater than a total number of generated element objects;
storing the generated element objects in a storage structure; and
providing the generated element objects from the storage structure within results for the database operation.

2. The method of claim 1, wherein every accessed database element having the same unique value corresponds with a single generated element object stored within the storage structure.

3. The method of claim 1, wherein database elements are accessed from at least one database table, and the method further comprises:
determining which database table columns are high frequency columns prior to generating an element object for database elements accessed from the high frequency columns, wherein the high frequency columns have a high frequency of re-use for unique database elements, the high frequency of re-use being greater than a threshold value.

4. The method of claim 3, wherein the generating of an element object for each different value of accessed database elements further comprises:
in response to a determination of a high frequency column, generating an element object a single time for each accessed database value having the same unique value.

5. The method of claim 1, wherein the database elements include raw data representing the unique values associated with the database elements, at least some of the database elements further include key values that facilitate accessibility to the raw data associated with the unique values, and accessing of database elements further comprises:
accessing a key value for at least one database element determined as having a high frequency of re-use within the database object, wherein the high frequency of re-use is greater than a threshold value.

6. The method of claim 1, further comprising:
obtaining from the database information regarding a frequency of re-use of at least some of the database elements in the database object.

7. A system for reducing memory usage of a database driver comprising:
a server including a database driver module and a storage structure, the database driver module configured with logic to:
access database elements from a database object within a database during a database operation;
generate an element object for each different value of accessed database elements, wherein the database object includes at least two database elements having the same unique value such that a total number of accessed database elements is greater than a total number of generated element objects;
store the generated element objects in the storage structure; and
provide the generated element objects from the storage structure within results for the database operation.

8. The system of claim 7, wherein the database driver module is further configured with logic to generate element objects such that every accessed database element having the same unique value corresponds with a single generated element object stored within the storage structure.

9. The system of claim 7, wherein the database driver module is further configured with logic to access database elements from at least one database table, and to determine which database table columns are high frequency columns prior to generating an element object for database elements accessed from the high frequency columns, where the high frequency columns have a high frequency of re-use for unique database elements, the high frequency of re-use being greater than a threshold value.

10. The system of claim 9, wherein the database driver module is further configured with logic such that, for each database table column determined to be a high frequency column, the database driver module generates an element object a single time for each accessed database value having the same unique value within the high frequency column.

11. The system of claim 7, wherein the database elements include raw data representing the unique values associated with the database elements, at least some of the database elements further include key values that facilitate accessibility to the raw data associated with the unique values, and the database driver module is further configured with logic to access a key value for at least one database element determined as having a high frequency of re-use within the database object, the high frequency of re-use being greater than a threshold value.

12. The system of claim 7, wherein the database driver module is further configured with logic to obtain from the database information regarding a frequency of re-use of at least some of the database elements in the database object.

13. A computer program product for reducing memory usage of a database driver comprising:
a computer readable storage medium having computer readable program code embodied therewith, the computer readable program code configured to:
access database elements from a database object within a database during a database operation;
generate an element object for each different value of accessed database elements, wherein the database object includes at least two database elements having the same unique value such that a total number of accessed database elements is greater than a total number of generated element objects;
store the generated element objects in the storage structure; and
provide the generated element objects from the storage structure within results for the database operation.

14. The computer program product of claim 13, wherein the computer readable code is further configured to generate element objects such that every accessed database element having the same unique value corresponds with a single generated element object stored within the storage structure.

15. The computer program product of claim 13, wherein the computer readable code is further configured to access database elements from at least one database table, and to determine which database table columns are high frequency columns prior to generating an element object for database elements accessed from the high frequency columns, where the high frequency columns have a high frequency of re-use for unique database elements, the high frequency of re-use being greater than a threshold value.

16. The computer program product of claim 15, wherein the computer readable code is further configured such that, for each database table column determined to be a high frequency column, the computer readable code generates an element object a single time for each accessed database value having the same unique value within the high frequency column.

17. The computer program product of claim 13, wherein the database elements include raw data representing the unique values associated with the database elements, at least some of the database elements further include key values that facilitate accessibility to the raw data associated with the unique values, and the computer readable code is further configured to access a key value for at least one database element determined as having a high frequency of re-use within the database object, the high frequency of re-use being greater than a threshold value.

18. The computer program product of claim 13, wherein the computer readable code is further configured to obtain from the database information regarding a frequency of re-use of at least some of the database elements in the database object.
